(19) United States
(12) Patent Application Publication
(10) Pub. No.: US 2001/0052916 A1
(43) Pub. Date: Dec. 20, 2001

(54) A SUBSTRATE FOR USE OF AN INK JET RECORDING HEAD, AN INK JET HEAD USING SUCH SUBSTRATE, A METHOD FOR DRIVING SUCH SUBSTRATE , AND AN JET HEAD CARTRIDGE, AND A LIQUID DISCHARGE APPARATUS

(76) Inventor: HIROKAZU KOMURO, KANAGAWA-KEN (JP)

Correspondence Address: FITZPATRICK CELLA HARPER & SCINTO, 30 ROCKEFELLER PLAZA, NEW YORK, NY, 10112, US

(21) Appl. No.: 08/901,661

(22) Filed: Jul. 28, 1997

(30) Foreign Application Priority Data
Jul. 31, 1996 (JP) 8-202245

(51) Int. Cl. B41J 2/05

(52) U.S. Cl. 347/58

(57) ABSTRACT

A substrate for an ink jet recording head is provided with a plurality of heat generating resistors for discharging ink. The wiring for applying the electric power supplied from outside to the plurality of heat generating resistors is divided into plural numbers, and each of the plurally divided wiring is arranged to provide substantially the same wiring resistive value from each of electrode pads arranged together therewith for receiving the supply of electric power from outside to each of the heat generating resistors. With the structure thus arranged, it is made possible to make the difference smaller in the voltage drop at the time of driving all the heat generating resisters simultaneously and driving only one of them, respectively, as well as to perform stabilized discharging of liquid for the formation of recorded images in good condition.

### BACKGROUND OF THE INVENTION

1. Field of the Invention

The present invention relates to a substrate for use of the ink jet recording head of an ink jet recording apparatus that forms droplets by discharging liquid from orifices. The invention also relates to a head using such substrate.

2. Related Background Art

With respect to an ink jet recording head of the kind, an ink jet recording method, such as disclosed in the specification of Japanese Patent Laid-open Application No. 54-51837, is to cause thermal energy to act upon liquid for obtaining the power source for discharging liquid. This is the characteristic aspect of the method that differs from the other types of ink jet recording methods. In other words, the recording method disclosed in the specification of the Laid-Open Application described above, liquid is heated by the activation of thermal energy in order to create bubbles, and by the acting force exerted by the creation of such bubbles, droplets are formed by means of orifices arranged at the leading end of the recording head unit. It is then characterized in that the droplets adhere to a recording member for recording information.

The recording head applicable to the recording method described above is generally provided with orifices arranged to discharge liquid; a liquid discharging unit having heat activating portions as a part of its structure, in which thermal energy acts upon liquid for discharging droplets, and which are conductively connected with the orifices; a heat generating resistive layer that forms electrothermal transducing elements to generating thermal energy; an upper layer that protects such elements from ink; and a lower layer that accumulates heat.

Also, in the specification of Japanese Patent Laid-open Application No. 57-72867, it has been proposed to incorporate an element for driving heat generating resistors on the substrate thereof in order to curtail the numbers of pads for external fetch electrodes.

FIG. 12 is a plan view which shows the conventional example of the structure having electric power wiring arranged on a substrate together with heat generating resistors.

The conventional example shown in FIG. 12 is a substrate used for the so-called edge shooter type ink jet recording head where liquid is discharged in the direction substantially in parallel with the heat generating surface of heat generating resistors (in the right-hand direction in FIG. 12).

On a silicon substrate, a heat generating resistive layer and electrode layer are produced, and then, by means of photolithographic technique, the heat generating elements 71 and the pads 73 for use of external fetch electrodes are formed. The size of each heat generating resistor 71 is 150 μm×30 μm. Eight resistors are produced at arrangement pitches of 200 μm.

Subsequently, a protection layer is formed. Then by means of photolithographic technique, the electrode pads 73 are formed, and also, through holes 74 are provided by making holes on the fetching unit of a common electrode. In continuation, a layer A1 is formed to serve the common electrode. Then, using photolithographic technique the common electrode 72 and the electrode pad 75 for use of external fetching for the common electrode 72 are formed.

In accordance with the conventional example thus structured, each of the electrode pads 73 is connected with one end of each heat generating resistor 71, while the other end thereof is connected with the common electrode 72 by way of each of the through holes 74 for its shareable use. Thus, heat is generated when voltage is applied across each of the electrodes 73 and 75.

Each of the heat generating elements 71 is separated and covered by the flow path walls (not shown) arranged between them. Liquid supplied into the space formed by such flow path walls is discharged from each of the orifices (not shown) by the creation of bubbles brought about by heat generated by each of the heat generating elements.

A plurality of electrode pads are arranged for the electric power wiring, and the electric power is supplied from outside through each of the electrode pads. Here, in order to make printing speed faster, the heat generating resistors should be arranged more. At the same time, many of such plural numbers of heat generating resistors should be driven simultaneously. When driving such plural numbers of heat generating resistors at a time, there are more instantaneous currents to be applied to the electric power wires.

The driving of the ink jet head that performs discharges by means of bubbling using thermal energy is different from that of the thermal head. For the normal bubbling, the pulse width should be made smaller to make the driving power greater. The driving current becomes greater accordingly. As a result, even if the electric power wiring is arranged with a lower resistance, there is still a problem encountered that the quality of printed images becomes inferior due to impediments, such as the inability to effectuate normal bubbling or disabled bubbling, because the voltage is caused to drop to the extant of the product of the difference that takes place in the electric currents when one heat generating resistor is driven and when many of them are driven at a time and the resistive value of the electric power wires, and also, because this inevitably results in the reduction of voltage applied to the heat generating resistors when many numbers of them are driven at a time.

Here, of the problems described above, the description will be made further by citing the specific numerical values. When thirty-two simultaneously driven heat generating resistors are arranged with the electric power wires at a resistive value of 1 Ω and the driving current of 0.2 A for each of the heat generating resistors, the current difference is 32×0.2−1×0.2=6.2 A, and the amount of the voltage drop is 6.2×1=6.2 V when one of them is driven and when all of them at a time, respectively.

When the driving voltage is set at 20 V, which is 1.3 times the bubbling voltage 15.3 V, the driving voltage 13.8 V, which is 20 V—such reduced voltage of 6.2 V, is lower than the bubbling voltage of 15.3 V. As a result, bubbling becomes impossible. In order to avoid this event, the applied voltage should be raised. However, if the applied voltage is raised, each of the heat generating resistors receives a greater voltage when each of them is driven individually. Therefore, the life of heat generating resistors is made shorter inevitably.

Also, it is in practice conventionally that the numbers of the heat generating resistors driven at a time are made smaller, while time division is set per driving cycle. Under the present circumstances, however, driving should be made at a high frequency in order to enhance the printing speed. Thus, the driving cycle is made extremely small accordingly. The factor that determines the driving cycle is mostly subjected to the responding capability of the driving element. Here, therefore, it is difficult to make the width of the driving pulse smaller still because of the limited responding capability of the driving element. As a result, the number of time divisions cannot be increased any more.

Also, conceivably, it may be possible to make the application of energy constant with respect to the heat generating resistors by widening the pulse width to the extent that the voltage may drop when applied to the heat generating resistors depending on the number of heat generating resistors to be driven at a time. In this case, however, there is a need for the provision of a logical circuit that control energy so that it may be applied constantly. This additional provision of the logical circuit leads to the inevitable increase of costs when manufacturing driving elements.

Also, it may be possible to make the wiring a thick film by means of plating techniques or the like in order to make the resistance of the electric power wiring lower. In this case, however, a protection layer should be provided, because there is a possibility that the wires are in contact with ink. Therefore, this provision of the protection layer on the thick film makes its upper surface higher than the surface of the heat generating resistors. This, in turn, makes it difficult to form nozzle members on the heat generating resistors, thus presenting another restriction in this respect. Particularly when the head should be produced finely to discharge ink droplets in high precision, the nozzles member is in the order of 10 μm when being formed, while the plated thick film wiring is also in the order of 10 μm. Here, therefore, the problem is more conspicuous.

In order to reduce the resistance of the electric power wiring, it is naturally required to make the electric power wires thicker. Then, the size of the substrate should be made larger accordingly. The costs of manufacture of the substrate becomes higher for the provision of heat generating elements, which occupy a larger percentage of costs in manufacturing heads. In order to prevent this, it may be conceivable to attempt increasing the number of pads for use of external fetch electrodes for the electric power wiring for the reduction of resistance of the external wiring plate. However, the increased number of pads not only invites the reduction of reliability, but also, necessitates making the size of substrate larger.

### SUMMARY OF THE INVENTION

In order to solve each of the problems described above, the present invention relates to a substrate for an ink jet recording head provided with a plurality of heat generating resistors for discharging ink, wherein the wiring for applying the electric power supplied from outside to the plurality of heat generating resistors is divided into plural numbers, and each of the plurally divided wiring has substantially the same wiring resistive value from each of electrode pads arranged together therewith for receiving the supply of electric power from outside to each of the heat generating resistors.

Also, a driving element is incorporated within such substrate for driving heat generating resistors.

Also, the plurally divided wiring is connected in the vicinity of the electrode pad.

Also, the electrode pads are arranged on the edge portion of such substrate to make the arrangement direction thereof different from the arrangement direction of such plurality of heat generating resistors.

Also, in order to solve each of the problems described above, the present invention relates to a method for driving the substrate structured as described above, which is characterized in that time divisional driving is performed for the heat generating resistors.

The ink jet head of the present invention uses the substrate for an ink jet recording head structured as described above.

The ink jet head cartridge of the present invention uses the ink jet head referred to in the preceding paragraph.

The liquid discharge apparatus of the present invention is provided with the ink jet head described above, and means for supplying driving signals in order to discharge liquid form such ink jet head.

In accordance with the present invention structured as described above, it is possible to arrange the resistive values of wiring to be almost the same from the electrode pads provided together with the heat generating resistors to receive the supply of electric power from outside up to each of the heat generating resistors, thus making the amount of voltage drop smaller for each of the heat generating resistors when all of them are driven and when each of them is driven, respectively. Then, with the reduction of the numbers of simultaneous driving by the application of the time divisional driving, it is made possible to reduce the divided numbers within the substrate, thus producing more favorable effect. Particularly, it is preferable to perform driving per block of the divided wiring.

Also, with the driving element being incorporated on the substrate, it is made possible to arrange the electric power wiring freely on the driving element, which facilitates both the division of wires and the adjustment of its resistive values.

Here, in particular, the numbers of fetching connections can be reduced by dividing the electric power wiring within the substrate and by connecting them with the electrode pads for external fetching.

Also, for the ink jet head that discharges ink vertically from the heat generating resistors, there is an advantage obtainable by arranging the pads for external fetching on the edge portions perpendicular to the arrangement direction of the heat generating resistors. In this way, the pad area can be made smaller. Also, it becomes easier to arrange each of the nozzle arrays.

In the cases described above, the electric power wiring can be divided for its effective arrangement to make the size of substrate smaller, leading to the significant reduction of costs of manufacture.

### BRIEF DESCRIPTION OF THE DRAWINGS

FIG. 1 is a plan view which shows a substrate in accordance with a first embodiment of the present invention.

FIG. 2 is a plan view which shows a substrate in accordance with a second embodiment of the present invention.

FIG. 3 is a plan view which shows a substrate in accordance with a third embodiment of the present invention.

FIG. 4 is a plan view which shows a substrate in accordance with a fourth embodiment of the present invention.

FIG. 5 is a plan view which shows a substrate in accordance with a fifth embodiment of the present invention.

FIG. 6 is a plan view which shows a substrate in accordance with a sixth embodiment of the present invention.

FIG. 7 is a perspective view which shows the structure of an edge shooter type ink jet head using the substrate in accordance with either one of the first embodiment to the third embodiment.

FIG. 8 is a perspective view which shows the structure of an edge shooter type ink jet head using the substrate in accordance with either one of the fourth embodiment to the sixth embodiment.

FIG. 9 is a structural view which schematically shows a liquid discharge apparatus.

FIG. 10 is a block diagram which shows the apparatus represented in FIG. 9.

FIG. 11 is a view which shows a liquid discharge recording system.

FIG. 12 is a plan view which shows the conventional substrate.

### DETAILED DESCRIPTION OF THE PREFERRED EMBODIMENTS

Now, with reference to the accompanying drawings, the description will be made of one embodiment in accordance with the present invention.

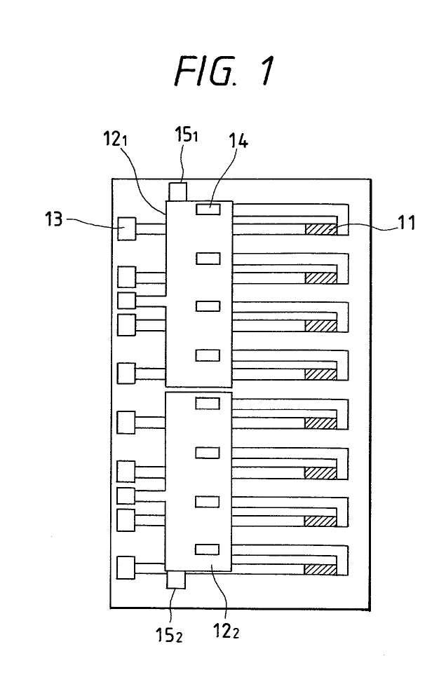

FIG. 1 is a plan view which shows a substrate for use of an ink jet recording head in accordance with a first embodiment of the present invention.

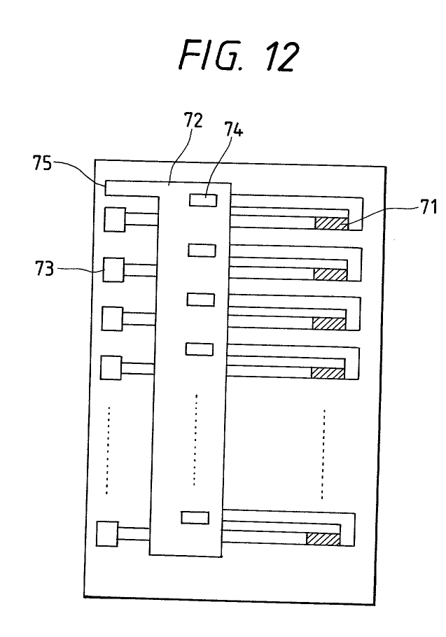

The present embodiment is a substrate for use of the so-called edge shooter type ink jet recording head that discharges liquid in the direction substantially in parallel with the heat generating surface of the heat generating resistors (in the right-hand direction in FIG. 1) as in the conventional example shown in FIG. 12.

A reference numeral 11 designates a heat generating resistor; 12, a common electrode (positive electrode); 13, a pad for use of external fetch electrode for the heat generating element 11; 14, a through hole that connects the electrode of the heat generating resistor and the common electrode; and 15, a pad for use of the external fetch electrode for the common electrode 12.

Given below the specific description will be made of the method of manufacture with respect to the present embodiment.

The substrate of the present embodiment is a substrate for use of an ink jet recording head whose discharging direction is in parallel with the heat generating resistors.

On a silicon substrate, a heat generating resistive layer and electrode layer are produced, and then, by means of photolithographic technique, the heat generating elements 11 and the pads 13 for use of external fetch electrodes are formed. The size of each heat generating resistor 11 is 150 μm ×30 μm. Eight resistors are produced at arrangement pitches of 200 μm.

Subsequently, a protection layer is formed. Then by means of photolithographic technique, the electrode pads 13 are formed, and also, through holes 14 are provided by making holes on the fetching unit of a common electrode. In continuation, a layer A1 is formed to serve the common electrode. Then, using photolithographic technique the common electrode 12 and the electrode pad 15 for use of external fetching with respect to the common electrode 12 are formed.

In accordance with the conventional example thus structured, each of the electrode pads 13 is connected with one end of each heat generating resistor 11, while the other end thereof is connected with the common electrode 12 by way of each of the through holes 14 for its shareable use. The electrode pads 13 are grounded. Thus, heat is generated when voltage is applied across each of the electrodes 13 and 15.

Each of the heat generating elements 11 is separated and covered by the flow path walls (not sown) arranged between them. Liquid supplied into the space formed by such flow path walls is discharged from each of the orifices (not shown) by the creation of bubbles brought about by heat generated by each of the heat generating elements.

The structure and the steps of manufacture of the present embodiment are the same as those described in conjunction with the conventional example shown in FIG. 12. However, the present embodiment differs from the conventional one in that the common electrodes 12₁ and 12₂ are provided by dividing the common electrode 12 into two, each having four heat generating resistors 11 respectively, and that two pads 15₁ and 15₂ are arranged for use of each of external fetch electrodes with respect to the common electrodes 12₁ and 12₂, respectively.

Now, hereunder, as compared with the conventional example shown in FIG. 12, the features of the present embodiment where the common electrodes are divided will be described specifically by citing numerical values thereof.

At first, the specific description will be made of the conventional example shown in FIG. 12, which now serves as the comparative example.

### COMPARATIVE EXAMPLE 1

The common electrode 72 shown in FIG. 12 has a dimension of 100 μm ×3,200 μm, with the sheet resistive value being 50 mΩ, and the resistive value being 0.05×3,200/100=1.6 Ω.

The bubbling voltage of the heat generating resistor 71 is 8 V. The driving voltage is set at 10 V, which is 1.25 times the bubbling voltage. The driving voltage is 0.2 A.

The difference between the driving currents when all the heat generating resistors 71 are driven and when only one heat generating resistor 71 is driven is 0.2 A×8−0.2 A=1.4 A.

The difference between the voltage values (the amount of voltage drop) when all the heat generating resistors 71 are driven and when only one heat generating resistor 71 is driven is 1.4 A×1.6Ω=2.2 V. Therefore, the voltage value becomes 7. 8 V when all the heat generating resistors are driven, thus making it impossible to bubble.

(Embodiment 1)

Each of the common electrode 121 and 122 shown in FIG. 1 has a dimension of 100 μm×1,600 μm, with the sheet resistive value being 50 mΩ, and the resistive value being 0.05×1,600/100=0.8 Ω.

The difference between the driving currents when all the heat generating resistors 11 are driven and when only one heat generating resistor 11 is driven is 0.2 A×8−0.2 A=1.4 A. However, since the common electrodes of the present embodiment are divided into two, that is, common electrodes 12₁ and 12₂, the actual value of current running on each of the common electrodes 12₁ and 12₂ is divided, and the difference in the actual driving current is 0.2 A×4−0.2 A=0.6 A.

Therefore, the difference between the voltage values (the amount of voltage drop) when all the heat generating resistors 11 are driven and when only one heat generating resistor 11 is driven is 0.6 A×0.8 Ω=0.48 V, and the voltage value becomes 9.52 V when all the heat generating resistors are driven, thus no problem being encountered in the bubbling operation.

As described above, the common electrodes of the substrate for use of ink jet operation of the present embodiment are divided to make the resistive value of the common electrodes itself lower, and at the same time, to make the difference between the actual driving currents smaller. As a result, bubbling is effectuated without any problem even when all the heat generating elements are driven at a time. Hence, even an ink jet recording head that uses a higher grade substrate can perform its stabilized recording without making the size of the substrate larger. Such ink jet recording head can be manufactured at lower costs.

(Embodiment 2)

Now, the description will be made of another embodiment in accordance with the present invention.

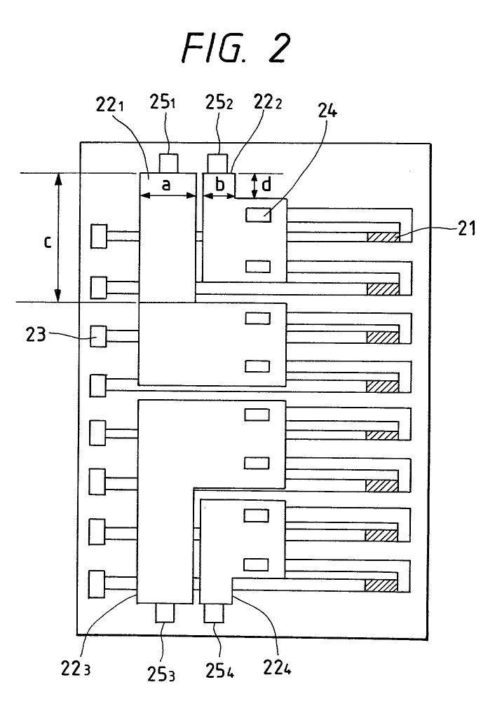

FIG. 2 is a view which shows the structure of a second embodiment in accordance with the present invention. The heat generating resistors 21, electrode pads 23, and through holes 24 are the same as the heat generating resistors 11, electrode pads 13, and through holes 14 shown in FIG. 1. However, in accordance with the present embodiment, the common electrodes are divided into four common electrodes 22₁, to 22₄, each corresponding to two heat generating resistors 21. Then, pads 25₁, to 25₄ are arranged for use of external fetch electrodes accordingly.

As shown in FIG. 2, each of the common electrodes 22₁ to 22₄ are arranged symmetrically to the center of the arrangement direction of the heat generating resistors 21 (symmetrically to the line that divides FIG. 2 into two in the top to bottom direction). The resistive values are determined by the lengths a and c for the common electrodes 22₁ and 22₃ and by the lengths b and d for the common electrodes 22₂ and 22₄. The dimensions of the lengths a to d are: a=100 μm; b=25 μm; c=400 μm; and d=100 μm. The sheet resistive value is 50 mΩ. The resistive value of the common electrodes 22₁ and 22₃, which are determined by the lengths a and c, is 0.05×400/100=0.2 Ω. The resistive value of the common electrodes 22₂ and 22₄, which are determined by the lengths b and d, is 0.05×100/25=0.2 Ω.

In accordance with the present embodiment, the common electrodes are divided still more. As compared with the first embodiment, it is possible to attempt the further reduction of resistance of the common electrodes. The amount of voltage drop when all the heat generating resistors 21 are driven is (0.2 A×8/ 4−0.2 A×1)×0.2=0.04 V. As a result, there is almost no problem in this respect.

Also, by selecting the dimensions that determine the resistive values as described above, it is possible to uniformalize the resistive value of each of the supply electrodes 22 even if the edge surfaces are different for the formation of electrode pads 23 and electrode pads 25. As a result, discharging characteristics become superior.

(Embodiment 3)

Now, the description will be made of another embodiment in accordance with the present invention.

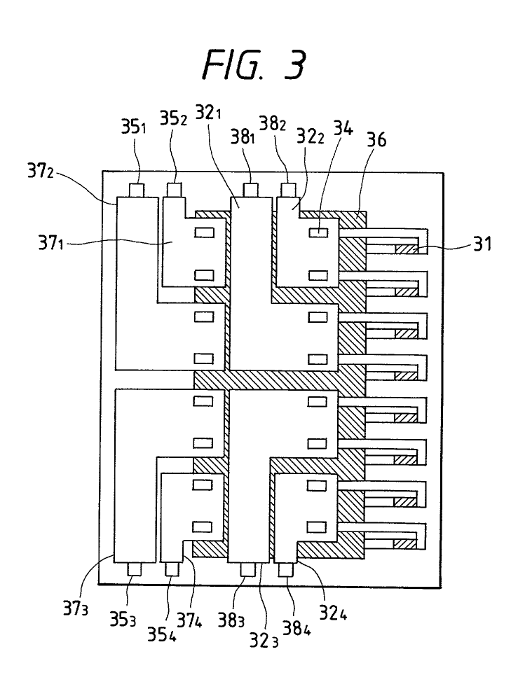

FIG. 3 is a view which shows the structure of a third embodiment in accordance with the present invention. The arrangement and configurational dimensions of the heat generating resistors of the present embodiment are the same as those of the heat generating resistors shown in FIG. 1.

In accordance with the present embodiment, a driving element 36 is incorporated by means of the NMOS processing on the substrate of the heat generating resistors 31 in order to drive them.

The driving element 36 is arranged to drive the heat generating resistors 31 in response to data signals inputted from outside to the input terminals (not shown), and also, to clock signals, as well as to signals that indicate the pulse width, among some others. For the driving element 36, the positive voltage and grounding voltage of the driving voltage are provided through the common electrodes in order to drive the heat generating resistors 31. With the structure thus arranged, the electrode pads, which have been arranged individually for each of the heat resistors for use of external fetching, are eliminated, thus reducing the number of electrode pads.

For the driving element 36, the grounding voltage is supplied through the electrode pads 35₁, to 35₄, common electrodes 31₁ to 37₄, and through holes 34. The positive voltage is supplied likewise through the electrode pads 38₁ to 38₄, common electrodes 32₁ to 32₄, and through holes 34. The configurational dimensions of the common electrodes 37₁ to 37₄, and 32₁ to 32₄ are arranged so that the resistive values thereof are made equal to those of the common electrodes 25₁, to 25₄ described in conjunction with the embodiment 2. Also, the electrode pads 35₁ to 35₄, and 38₁ to 38₄, which are arranged together with each of the common electrodes 37₁, to 37₄, and 32₁ to 32₄, are arranged on the edge surface substantially perpendicular to the arrangement direction of the heat generating resistors 31.

In accordance with the present embodiment structured as above, the amount of voltage drop should be taken into account on two aspects when voltage is applied to all the heat generating resistors 31 at the time of driving, because the common electrodes receive the positive voltage and the grounding voltage. Therefore, as compared with the first and second embodiments, the causes of reduction become two times, and are severer. However, since the common electrodes are divided into four, the amount of actual voltage drop is (0.2 A×8/4−0.2 A )×0.2×2=0.08 V. Hence, there is no problem, and bubbling and liquid discharging are executable in good condition.

(Embodiment 4)

Now, the description will be made of another embodiment in accordance with the present invention.

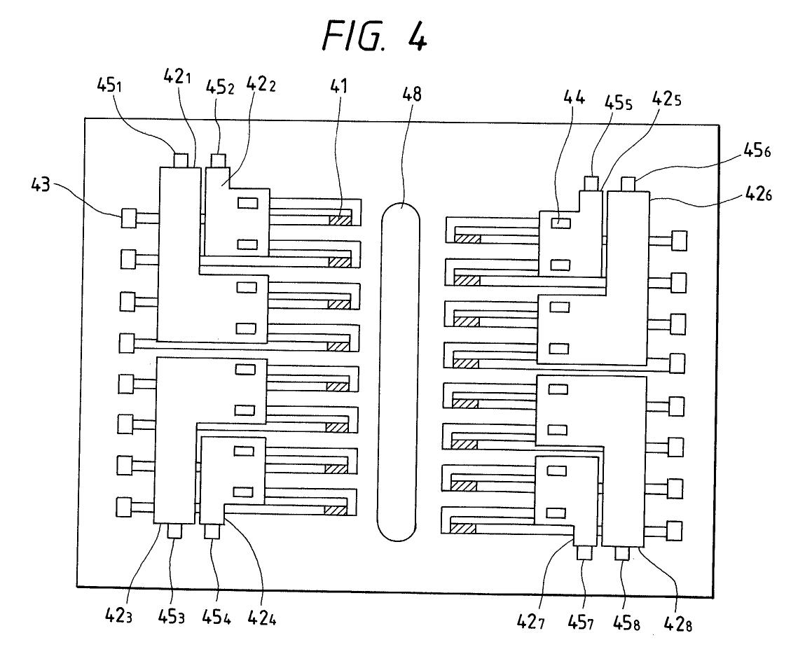

FIG. 4 is a view which shows the structure of a fourth embodiment in accordance with the present invention. Whereas each of the embodiments shown in FIG. 1 to FIG. 3 is the substrate for use of the edge shooter type ink jet recording head where liquid is discharged in the direction substantially in parallel with the heat generating surface of the heat generating resistors, the present embodiment is a substrate for use of the side shooter type ink jet recording head where liquid is discharged in the direction substantially perpendicular to the heat generating surface of the heat generating resistors.

Each of the heat generating resistors 41 of the present embodiment has two heat generating resistors, each having the same arrangement and configurational dimensions as those of the heat generating resistor 11 of the embodiment 1. Each set that comprises a plurality of heat generating resistors 41 is arranged in a staggered fashion to face each other. Between each of the sets, an ink supply port 48 is open by means of blast processing.

For the set of the heat generating resistors 41 positioned on the left-hand side in FIG. 4, grounding voltage is provided through the electrode pads 45₁, to 45₄, common electrodes 42₁, to 42₄, and through holes 44. For the set of the heat generating resistors 41 positioned on the right-hand side in FIG. 4, positive voltage is provided through the electrode pads 45₅ to 45₈, common electrodes 42₅, to 42₈, and through holes 44. Also, the individual driving of each heat generating resistor 41 is performed by means of the electrode pads 43 arranged or each of the heat generating resistors 41 as in the case of the first and second embodiments.

The configurational dimensions of the common electrodes 42₁, to 42₄, and 42₅, to 42₈ are arranged so that the resistive values thereof are made equal to those of the common electrodes 25₁ to 25₄ described in conjunction with the embodiment 2, respectively. Also, the electrode pads 42₁ to 42₄, and 42₅, to 42₈, which are arranged together with each of the common electrodes 42₁ to 42₄, and 42₅ to 42₈, are arranged on the edge surface substantially perpendicular to the arrangement direction of the heat generating resistors 41.

In accordance with the present embodiment as described above, ink, which is provided for the ink supply port 48 from the structure or the like configured by the flow path wall that surrounds each of the heat generating resistors and discharge ports, is supplied onto each of the heat generating resistors 41 through each of the flow paths, and then, by means of bubbling, the ink is discharged vertically above the surface of FIG. 4.

The structure of the common electrodes of the present embodiment is the same as the embodiment 2 as described above. The voltage drop is also the same. Bubbling is performed without any problem for discharging liquid in good condition.

(Embodiment 5)

Now, the description will be made of another embodiment in accordance with the present invention.

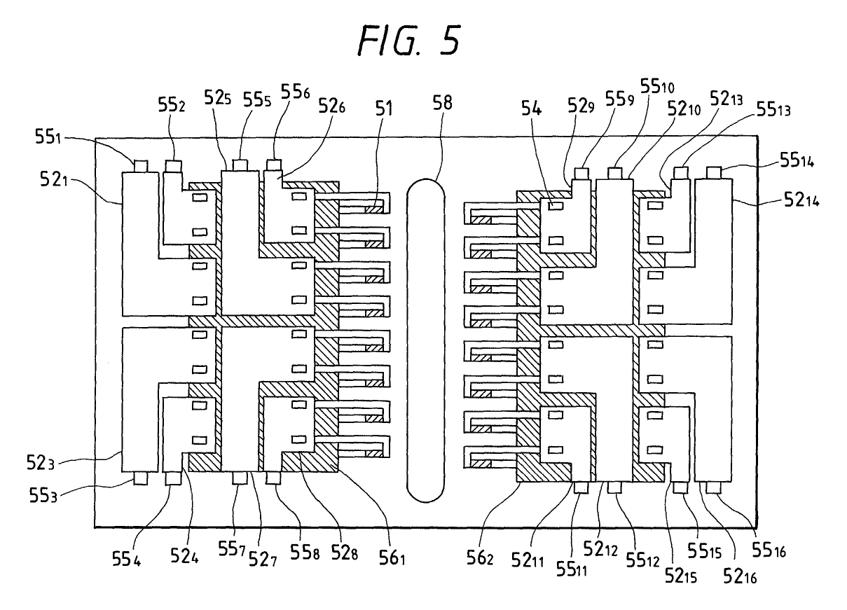

FIG. 5 is a view which shows the structure of a fifth embodiment in accordance with the present invention. The present embodiment is a substrate for use of the side shooter type ink jet recording head where liquid is discharged in the direction substantially perpendicular to the heat generating surface of the heat generating resistors as in the fourth embodiment shown in FIG. 4.

Each of the heat generating resistors 51 of the present embodiment has two heat generating resistors, each having the same arrangement and configurational dimensions as those of the heat generating resistor 11 of the embodiment 1. Each set that comprises a plurality of heat generating resistors 51 is arranged in a staggered fashion to face each other. Between each of the sets, an ink supply port 58 is open by means of blast processing.

For the present embodiment, driving elements 56₁ and 56₂ to drive the heat generating resistors 51 are incorporated on the substrate by means of NMOS processing as in the embodiment 3 shown in FIG. 3. As described above, each of the heat generating resistors 51 is arranged in the staggered fashion in accordance with the present embodiment, and for the set of the heat generating resistors 51 positioned on the left-hand side in FIG. 5, grounding voltage is provided through the electrode pads 55₁ to 55₄, common electrodes 52₁ to 52₄, and through holes 54, and positive voltage is provided through the electrode pads 55₅ to 55₈, common electrodes 52₅ to 52₈, and through holes 54. For the set of the heat generating resistors 51 positioned on the right-hand side in FIG. 5, positive voltage is provided through the electrode pads 55₉ to 55₁₂, common electrodes 52₉ to 52₁₂, and grounding voltage is provided through the electrode pads 55₁₃ to 55₁₆, common electrodes 52₁₃ to 52₁₆.

The configurational dimensions of the common electrodes 52₁ to 52₁₆ are arranged so that the resistive values thereof are made equal to those of the common electrodes 25₁ to 25₄ described in conjunction with the embodiment 2, respectively. Also, the electrode pads 55₁ to 55₁₆ which are arranged together with each of the common electrodes 52₁ to 52₁₆, are arranged on the edge surface substantially perpendicular to the arrangement direction of the heat generating resistors 51.

In accordance with the present embodiment, it is possible to make bubbling in good condition when the heat generating resistors are driven at a time as in each of the embodiments described above.

(Embodiment 6)

Now, the description will be made of another embodiment in accordance with the present invention.

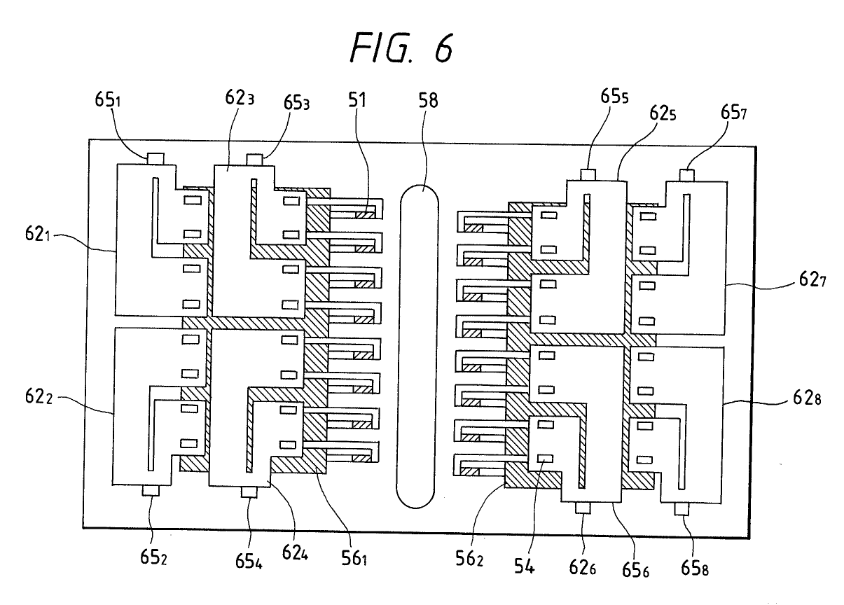

FIG. 6 is a view which shows the structure of a sixth embodiment in accordance with the present invention. The present embodiment is the mode in which the electrode pads are curtailed for use of the external fetching for the common electrodes of the fifth embodiment shown in FIG. 5. The common electrodes 62₁, to 62₈ are configured such as to couple the common electrodes 52₁ and 52₂, 52₃ and 52₄, 52₅ and 52₆, 52₇ and 52₈, 52₉ and 52₁₀, 52₁₁ and 52₁₂, 52₁₃ and 52₁₄, 52₁₅, and 52₁₆ shown in FIG. 5, respectively. Then, electrode pads 65₁, to 65₈ are arranged together with each of the common electrodes 62₁ to 62₈. All the other structures of the present embodiment are the same as those of the fifth embodiment. Therefore, while applying the same reference marks to such structures as those appearing in FIG. 5, the description thereof will be omitted.

Each of the common electrodes 62₁ to 62₈ is configured to be in the form that each of the electrodes shown in FIG. 5 is coupled in the vicinity of each of the electrode pads 65₁ to 65₈. In this way, the amount of voltage drop is made almost equal to that of the fifth embodiment, while curtailing the number of the electrode pads for use of external fetching for the common electrodes by 50%.

Also, in accordance with the present embodiment, the electrode pads 65₁ to 65₈ for use of driving the driving element are arranged on the edge surface perpendicular to the arrangement direction of the heat generating resistors 61. As a result, the area where the electrode pads are formed becomes relative sides. Then, perpendicular to these sides, the terminals (not shown) are arranged, through which are inputted data signals, clock signals, and signals that indicate the pulse width, among some others. In this way, the pads formed on the substrate become bidirectional to make it possible to reduce the size of the substrate.

Also, each of the substrates shown in FIG. 6 can be coupled side by side. With such arrangement, it is possible to fabricate a substrate for use of color recording where a pair of supply ports for ink of different colors, such as magenta, cyan, yellow, and black, are provided, for example. In this case, too, the amount of voltage drop can be minimized.

Further, as the driving method, it may be possible to cite a method whereby to divide the two heat generating resistors connected with each of the common electrodes into two during the driving cycle. With the driving thus arranged, the driving current flowing to each of the common electrodes is made equal when all the heat generating resistors are driven and when only one of them is driven. Then, the voltage drop of the common electrodes becomes the same at the time of driving all the heat generating resistors and only one of them.

As a result, designing is possible without giving any consideration to the event that may be brought about by the difference in the voltage drop. The bubbling capability becomes constant irrespective of the number of heat generating resistors to be driven. In other words, the discharging performance becomes constant, hence making it possible to provide an ink jet recording head having a stabilized printing performance.

(Ink Jet Head)

Now, the description will be made of the embodiment of an ink jet head using the ink jet substrate shown for each of the embodiments structured as described above.

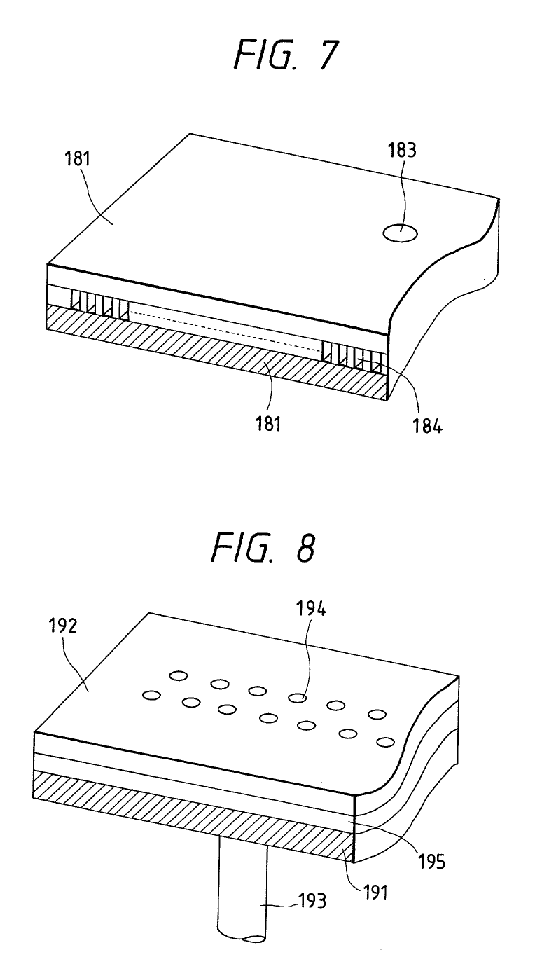

FIG. 7 is a perspective view which shows the structure of an edge shooter type ink jet head using either one of the substrates according to the first to third embodiments shown in FIG. 1 to FIG. 3.

In accordance with the present embodiment, photo-sensitive resin is laminated on the substrate 181, which is structured according to either one of the first to third embodiments, and then, the flow path walls are formed by means of photolithographic technique. In continuation, the cover 182 provided with an ink supply port 183 is stacked on it, and cut to form discharge ports, discharge nozzles, and a liquid chamber at a time.

FIG. 8 is a perspective view which shows the structure of a side shooter type ink jet head using either one of the substrates according to the fourth to sixth embodiments shown in FIG. 4 to FIG. 6.

In accordance with the present embodiment, photosensitive resin is laminated on the substrate 191, which is structured according to either one of the fourth to sixth embodiments, and then, the flow path walls 195 are formed by means of photolithographic technique. In continuation, the orifice plate 192 provided with an ink supply port 194 is produced by means of electrocasting, and adhesively bonded on the flow path walls 195, hence forming discharge ports, discharge nozzles, and a liquid chamber at a time. Lastly, an ink supply tube 193 is adhesively bonded to the ink supply port of the substrate 191.

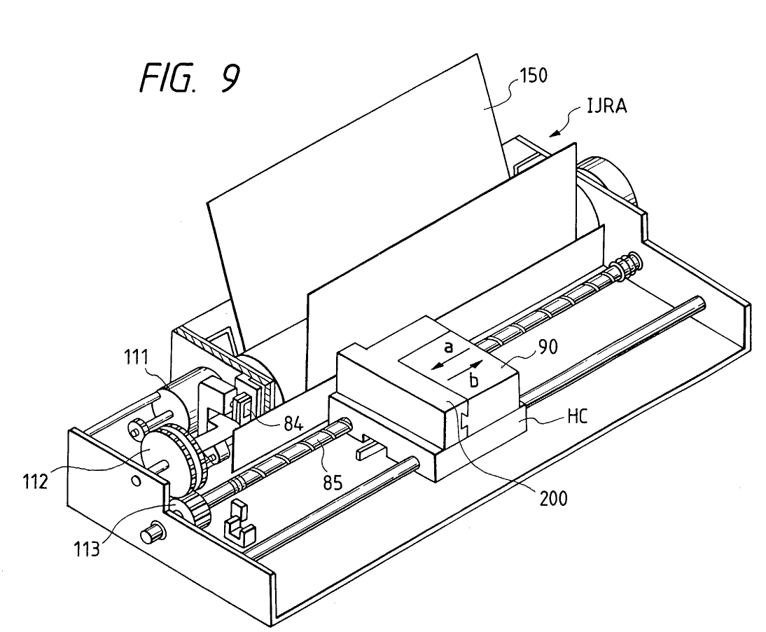

FIG. 9 is a view which schematically shows the liquid discharge apparatus that mounts the ink jet head described above. Here, particularly, the carriage HC of the liquid discharge apparatus, which is described using the ink jet recording apparatus that uses ink as discharging liquid, mounts the head cartridge detachably provided with a liquid tank unit 90 for containing ink and liquid discharge head unit 200, and reciprocates in the width direction of a recording medium, such as recording sheet being carried by recording medium carring means.

When driving signals are supplied to the liquid discharge head unit on the carriage HC from driving signal supply means (not shown), recording liquid is discharged from the liquid discharge head onto the recording medium in response to these signals.

Also, the recording apparatus is provided with a motor 111 as the driving source, gears 112 and 113, and carriage shaft 115 or the like to transfer the driving power from the driving source to the carriage. It is possible to obtain recorded objects having good images by discharging liquid onto various kinds of recording media by use of this recording apparatus and liquid discharging method adopted for the recording apparatus.

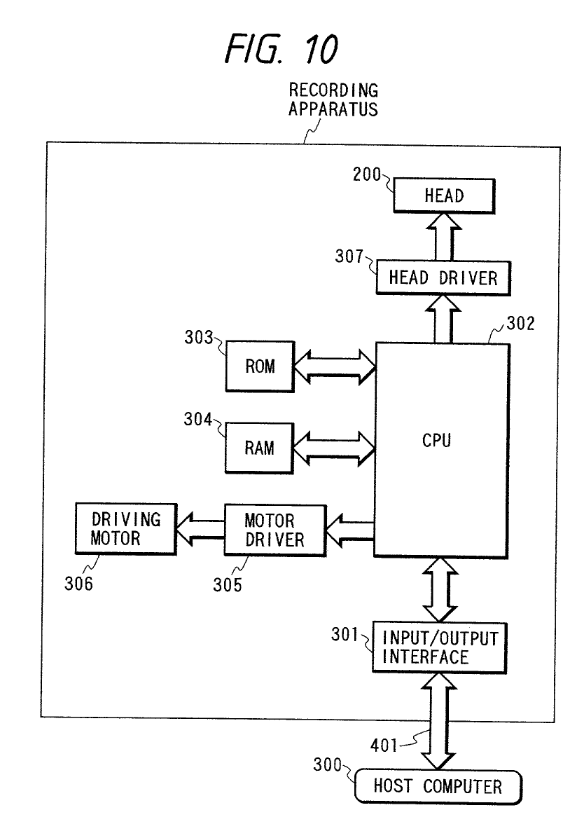

FIG. 10 is a block diagram which shows the recording apparatus as a whole, which discharges ink for recording by the application of the liquid discharging method and by use of the liquid discharge head of the present invention.

This recording apparatus receives printing information from a host computer 300 as control signals. The printing information is provisionally stored in the input interface 301 of the recording apparatus. At the same time, the printing information is converted to the data that can be processed in the recording apparatus, thus being inputted into the CPU 302 that dually functions as means for supplying head driving signals. The CPU 302 processes the inputted data using peripheral units such as RAM 304 and others in accordance with the control program stored in the ROM 303, and converts them to printing data (image data).

Also, the CPU 302 produces driving data in order to drive the driving motor that carries the recording sheet and the recording head in synchronism with each other for recording the image data in appropriate positions on the recording sheet. The image data and driving data are transferred to the head 200 and driving motor 306 through the head driver 307 and the motor driver 305, respectively, which are driven in accordance with the controlled timing to form images.

As the recording medium usable for the recording apparatus described above to provide ink or the like for it, there can be named various paper and OHP sheets, plastic materials used for compact disc, ornamental board, or the like, cloths, metallic materials such as aluminum and copper, cattle hide, pig hide, artificial leathers or other leather materials, wood, plywood, bamboo, tiles and other ceramic materials, sponge or other three-dimensional structures.

Also, as the recording apparatus described above, there can be named a printing apparatus for recording on various paper and OHP sheets, a recording apparatus for use of plastic media to record on compact disc and other plastic materials, a recording apparatus for recording on metallic plates, a recording apparatus for recording on leathers, a recording apparatus for recording on woods, a recording apparatus for recording on ceramics, a recording apparatus for recording on a three-dimensional net structure such as sponge. Also, a textile printing apparatus or the like that records on cloths is included.

As discharging liquid used for these liquid discharge apparatuses, it may be possible to use any one of the liquids depending on the kinds of recording media and recording condition.

(Recording System)

Now, the description will be made of one example of ink jet recording system that uses the liquid discharge head of the present invention as its recording head to perform recording on a recording medium.

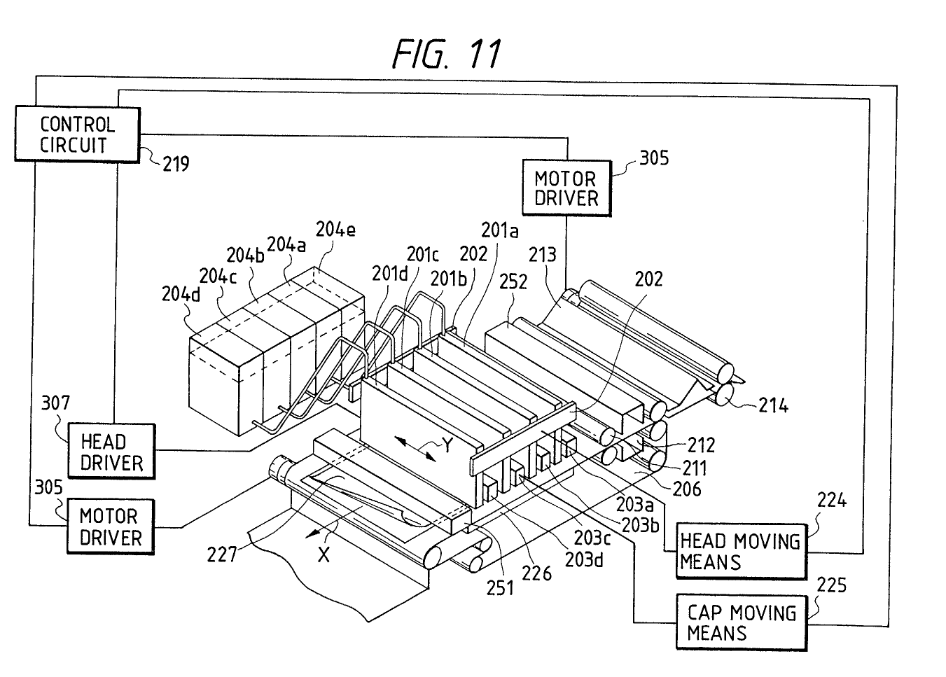

FIG. 11 is a view which schematically illustrate the structure of this ink jet recording system using the liquid discharge head 201 of the present invention described above. The liquid discharge head of the present embodiment is a full line type head where a plurality of discharge ports are arranged in the length that corresponds to the recordable width of a recording medium 150 at the intervals (density) of 360 dpi. Four liquid discharge heads 201a, 201b, 201c, and 201d are fixedly supported by the holder 202 in parallel to each other at given intervals in the direction X corresponding to four colors, yellow (Y), magenta (M), cyan (C), and black (Bk), respectively.

From the head driver 307 constituting driving signal supplying means, signals are supplied to each of the liquid discharge heads.

To each of the heads, four different color ink, Y, M, C, Bk, are supplied from the ink containers 204a to 204d as discharging liquid, respectively. Here, a reference numeral 204e designates the bubbling liquid container, and the structure is arranged to supply bubbling liquid to each of the liquid discharge heads.

Also, below each of the liquid discharge heads, head caps 203a to 203d are arranged with sponge or other ink absorbing material contained in them, which cover the discharge ports of the liquid discharge heads in order to maintain each of the heads when recording operation is at rest.

Here, a reference numeral 206 designates a carrier belt which is arranged to constitute carrier means for carrying each kind of recording medium as described earlier for each of the embodiments. This carrier belt 206 is drawn around various rollers at given passage and driven by driving rollers connected with the motor driver 305.

Also, for the ink jet recording system of the present embodiment, a pre-processing device 251, and post-processing device 252 are installed on the upstream and downstream of the recording medium carrier passage to perform various processes with respect to the recording medium before and after recording.

The pre-processing and post-processing are different in the contents of the corresponding process depending on the kinds of recording media and kinds of ink. For example, with respect to recording on a medium such as metal, plastic, or ceramic, ultraviolet lays and ozone are irradiated to activate the surface of the medium used, thus improving the adhesion of ink thereto. Also, when recording on a medium, such as plastic, that easily generates static electricity, dust particles are easily attracted to the surface thereof to hinder good recording in some cases. Therefore, as the pre-processing device, an ionizer is used to remove static electricity. In this way, dust particles should be removed from the recording medium. Also, when cloths are used as a recording medium, a pre-processing may be performed to provide a substance selected from among alkali substance, water-soluble substance, synthetic polymer, water-soluble metallic salt, urea, and thiourea for recording on cloths in order to prevent stains on them, while improving its coloring rate. However, the pre-processing is not necessarily limited to those described above. It may be the process to adjust the temperature of a recording medium appropriately to a temperature suited for recording on such medium.

On the other hand, fixation process is performed as the post-processing to promote the fixation of ink by executing heating process or irradiation of ultraviolet rays, among some others, for the recording medium for which ink has been provided. Cleaning process is also performed as a post-processing to rinse off the processing agent provided for the recording medium in the pre-processing but still remaining inactive.

Here, the description has been made in assumption that a full line head is used as the liquid discharge head, but the present invention is not necessarily limited to the full line head. It may be possible to apply the present invention to such a mode that the smaller liquid discharge head described earlier is carried in the width direction of a recording medium for recording.

As described above, in accordance with the present invention, the electric power wiring is divided into plural numbers on and within the substrate for use of an ink jet recording head, while arranging them so that the resistive values of wiring are made almost the same up to the pads for external fetching. In this way, it is possible to make the difference smaller in the voltage drop for the common electrodes when all the heat generating resistors are driven and when only one of them is driven, respectively.

The numbers of heat generating resistors, which are connected with each of the wires and are driven at a time, are arranged to be one heat generating resistor, thus making it possible to eliminate the voltage drop at the time of driving all the heat generating resistors and only one of them. Then, with the reduction of the numbers of simultaneous driving by the application of the time divisional driving, it is made possible to reduce the divided numbers within the substrate, thus producing more favorable effect in this respect.

Also, with the driving element being incorporated on the substrate, it becomes possible to arrange the electric power wiring freely on the driving element, which facilitates both the division of wires and the adjustment of its resistive values.

Particularly, it is possible to reduce the numbers of fetching connections by dividing the electric power wiring within the substrate and by connecting them with the electrode pads for external fetching.

Also, for the ink jet head that discharges ink vertically from the heat generating resistors, there is an advantage obtainable by arranging the pads for external fetching on the edge portions perpendicular to the arrangement direction of the heat generating resistors. In this way, the pad area can be made smaller. Also, it becomes easier to arrange each of the nozzle arrays.

In the cases described above, the electric power wiring can be divided for its effective arrangement to make the size of substrate smaller, leading to the significant reduction of costs of manufacture.

What is claimed is:

1. A substrate for an ink jet recording head provided with a plurality of heat generating resistors for discharging ink,
the wiring for applying the electric power supplied from outside to said plurality of heat generating resistors being divided into plural numbers; and
each of said plurally divided wiring having substantially the same wiring resistive value from each of electrode pads arranged together therewith for receiving the supply of electric power from outside to each of said heat generating resistors.

2. A substrate for an ink jet recording head according to claim 1, wherein a driving element is incorporated within said substrate for driving heat generating resistors.

3. A substrate for an ink jet recording head according to any one of claims 1 to 2, wherein the plurally divided wiring is connected in the vicinity of the electrode pad.

4. A substrate for an ink jet recording head according to claim 1, wherein said electrode pads are arranged on the edge portion of said substrate to make the arrangement direction thereof different from the arrangement direction of said plurality of heat generating resistors.

5. A driving method for a substrate for an ink jet recording head according to any one of claims 1 to 4,
time divisional driving being performed for said heat generating resistors.

6. A driving method for a substrate for an ink jet recording head according to claim 5, wherein said time divisional driving is performed dividedly per block of divided wiring.

7. An ink jet head using a substrate for an ink jet recording head according to any one of claims 1 to 4.

8. An ink jet head cartridge having an ink jet head according to claim 7 combined with a container retaining ink therein.

9. A liquid discharge apparatus comprising:
an ink jet head according to claim 7; and
means for supplying driving signals to supply driving signals for discharging liquid from said ink jet head.
